(19) United States
(12) Patent Application Publication
(10) Pub. No.: US 2021/0337996 A1
(43) Pub. Date: Nov. 4, 2021

(54) NON-RETURN MECHANISM FOR A MOTOR OF AN ELECTRIC CURTAIN

(71) Applicant: NINGBO SUNFREE MOTOR TECHNOLOGY COMPANY LIMITED, NINGBO (CN)

(72) Inventors: Yongqiang ZHOU, NINGBO (CN); Jianhong WEI, NINGBO (CN); Chun JIANG, NINGBO (CN)

(21) Appl. No.: 17/196,015

(22) Filed: Mar. 9, 2021

(30) Foreign Application Priority Data
Apr. 30, 2020 (CN) 202010363082.1

(51) Int. Cl. A47H 5/032; F16H 57/021; H02K 7/116

(52) U.S. Cl. CPC A47H 5/0325; H02K 7/116; F16H 57/021

(57) ABSTRACT

A non-return mechanism for a motor of an electric curtain is provided which comprises a motor and a gearbox that are successively connected; the output end of the gearbox is connected with a non-return component; the non-return component comprises a flange, an output shaft and a non-return block, the output end of the gearbox is provided with an output bracket; the output bracket is in unidirectional drive fit with one end of the output shaft toward the gearbox and they fit within the accommodating cavity; the output shaft and the non-return block, together with the unidirectional drive fit with the output bracket, a non-return force is effectively generated to steadily maintain the curtain at the required position when the motor stops without damaging the gearbox and the motor as the output shaft reversely drives the gearbox and the motor under the effect of an external force or gravity.

### CROSS-REFERENCE TO RELATED APPLICATIONS

This application claims priority to Chinese Patent Application No. 202010363082.1 with a filing date of Apr. 30, 2020. The content of the aforementioned application, including any intervening amendments thereto, are incorporated herein by reference.

### TECHNICAL FIELD

The present invention relates to the technical field of motors of electric curtains, in particular to a non-return mechanism for a motor of an electric curtain.

### BACKGROUND

As people's living standard continuously raises, an electric and intelligent curtain becomes more and more popular. Considering that large windows of high-end residences usually provide marvelous sunshine experience for consumers, curtains tend to be larger and larger accordingly. In this case, more requirements on motors of the curtains have been brought up, for instance, the size of the motor is better to be smaller, with larger output torque and non-return force, lower operation noise, and higher stability.

The working principle of a motor of a curtain generally includes: sending a forward or reverse rotation order to a DC motor through the control system, the DC motor retards a motor and increases output torque through a gearbox, and a curtain fabric is driven by an output shaft to operate, thereby opening or closing the curtain. In this process, when the motor is loaded, it moves to the designated position silently and does not slip. The key technical difficulty lies in that after the curtain stops, its motor can provide enough non-return force to offset the gravity of the curtain, so that the curtain can be maintained at the required position steadily.

The non-return braking property of the motor plays a vital role to ensure a steady operation, and the existing non-return drive scheme is that by increasing the cogging torque of the rotor of the DC motor and the reverse electromotive force produced by motor short circuit, non-return drive is achieved through amplification of a reduction gearbox. However, a larger cogging torque mainly causes loud noise of the DC motor, the service life of the DC motor is greatly reduced if the motor is short circuited to produce reverse electromotive force for brake, and the non-return forces provided from these two directions are insufficient to meet the requirements of large curtains.

By adding magnets and iron cores between the motor output shaft and the teeth of the motor to increase static torque or improve the non-return force of the motor of the curtain through spring friction, the motor of the curtain is prevented from slipping. Whereas, the above effect is realized at the cost of the efficiency and service life of the motor, while the defects of loud noise and low efficiency are obvious at the same time.

Besides, in actual use, the curtain may instantaneously produce an impact force to the gear of its motor under the effect of external factors such as heavy wind or pulling by hands, even directly damage the gearbox and core of the motor of the curtain, leading to failure of the whole curtain. The above is the after-sale problems frequently occurring in the existing scheme. Therefore, how to effectively provide a non-return force so as to steadily maintain the curtain at the required position when the motor stops but have no harm to the motor and the gearbox is the issue that urgently needs to be resolved at present.

### SUMMARY

One objective of the present disclosure is to overcome the shortcomings of the prior arts by providing a non-return mechanism for a motor of an electric curtain, which not only effectively provides a non-return force to steadily maintain the curtain at the required position when the motor stops, but also prevents the gearbox and the motor from being damaged as the output shaft reversely drives the gearbox and the motor under the effect of an external force or gravity.

The technical solution adopted to resolve the above technical problem provides a non-return mechanism for a motor of an electric curtain, comprising a motor and a gearbox that are successively connected. The output end of the gearbox is connected with a non-return component. The non-return component comprises a flange, an output shaft and a non-return block. The flange is internally provided with an accommodating cavity. The output end of the gearbox is provided with an output bracket. The output bracket is in unidirectional drive fit with one end of the output shaft toward the gearbox and they fit within the accommodating cavity. The non-return block is arranged at the joint of the output bracket and the output shaft. The flange is connected with the gearbox.

Further, the end portion of one end of the output shaft toward the gearbox is provided with at least one arc-shaped groove that is concave along the radial direction. The non-return blocks are accommodated within the arc-shaped groove. A poke rod for poking the non-return block extends from the output bracket and fits within the arc-shaped groove.

Further, a brake block is bulged from the bottom of the arc-shaped groove and divides the arc-shaped groove into two symmetrical cavities that are intercommunicated to each other. The non-return blocks are symmetrically accommodated within the two cavities. The poke rod extends into the arc-shaped groove and locates between two non-return blocks.

Further, the distance from the bulged surface of the brake block to the inner wall of the accommodating cavity is greater than the thickness of the poke rod but less than the width of the non-return block.

Further, the non-return blocks are in clearance fit with both the inner walls of the cavities and the inner wall of the accommodating cavity.

Further, three arc-shaped grooves are provided and disposed along the circumferential direction of the end portion of one end of the output shaft toward the gearbox equidistantly. Six non-return blocks are provided. The quantity and positions of the poke rod correspond to those of the arc-shaped groove.

Further, the center of the end portion of one end of the output shaft toward the gearbox is provided with a locating shaft in a protruded manner. A shaft hole matched with the locating shaft is formed on the output bracket.

Further, one end of the flange away from the gearbox is provided with a through hole. The through hole is communicated with the accommodating cavity. There forms a step surface on the joint of the through hole and the accommodating cavity. A locating step matched with the step surface is formed on the output shaft. One end of the output shaft away from the gearbox penetrates through the through hole and is exposed outside the flange. An annular slot is formed on the portion of the output shaft exposed outside the flange. A circlip is clamped on the annular slot. The circlip clings to the end surface of one end of the flange away from the gearbox.

Further, the non-return blocks are spheres.

Further, one end of the output shaft away from the gearbox, is used as a driving head for linkage with an external portion.

As compared to the prior art, the non-return mechanism for a motor of an electric curtain disclosed by the invention has the following advantages that the flange, the output shaft and the non-return blocks jointly cooperate with the output bracket of the gearbox so as to achieve unidirectional drive fit. That is to say, when the motor drives the output bracket to rotate, the output bracket pokes the non-return block, and the non-return block pushes against the inner wall of the arc-shaped groove of the output shaft, thereby driving the output shaft to synchronously rotate; when the motor ceases, the output bracket stops rotation, the curtain, under the effect of an external force or own gravity drives the output shaft, but at this time, the output shaft is locked so as not to reversely drive the output bracket, thereby avoiding damaging the gearbox and the motor on the grounds that when the output shaft rotates, the arc-shaped groove pushes the non-return block which is locked as the movable clearance between the non-return block and the inner wall of the accommodating cavity is reduced by the pushing of the arc-shaped groove, so that the output shaft is prevented from reversely driving the output bracket, the gearbox and the motor are protected and their service lives are prolonged.

### BRIEF DESCRIPTION OF THE DRAWINGS

FIG. 1 is a schematically structural diagram of the present invention;

FIG. 2 is an exploded view of the present invention;

FIG. 3 is a schematically structural diagram of a non-return component of the present invention;

FIG. 4 is a schematically structural diagram of an output shaft of the present invention;

FIG. 5 is a schematically structural diagram of an output bracket of the present invention;

FIG. 6 is a cross-section view showing match of the non-return component and the output bracket of the present invention;

FIG. 7 is a cross-section view of the output bracket of the present invention in a forward rotation state;

FIG. 8 is a cross-section view of the output bracket of the present invention in a reverse rotation state;

FIG. 9 is a cross-section view of the output shaft of the present invention in a forward rotation state;

FIG. 10 is a cross-section view of the output shaft of the present invention in a reverse rotation state.

The numerals represent: 1 motor; 2 gearbox; 2.1 clamping groove; 3 flange; 3.1 accommodating cavity; 3.2 through hole; 3.3 step surface; 3.4 outer gear ring; 3.5 fastener; 4 output shaft; 4.1 arc-shaped groove; 4.2 brake block; 4.3 cavity; 4.4 locating shaft; 4.5 locating step; 4.6 annular slot; 4.7 driving head; 5 non-return block; 6 output bracket; 6.1 poke rod; 6.2 shaft hole; 7 circlip.

### DETAILED DESCRIPTION OF THE EMBODIMENTS

The present invention will be described in detail in the following documents with reference to the appended drawings.

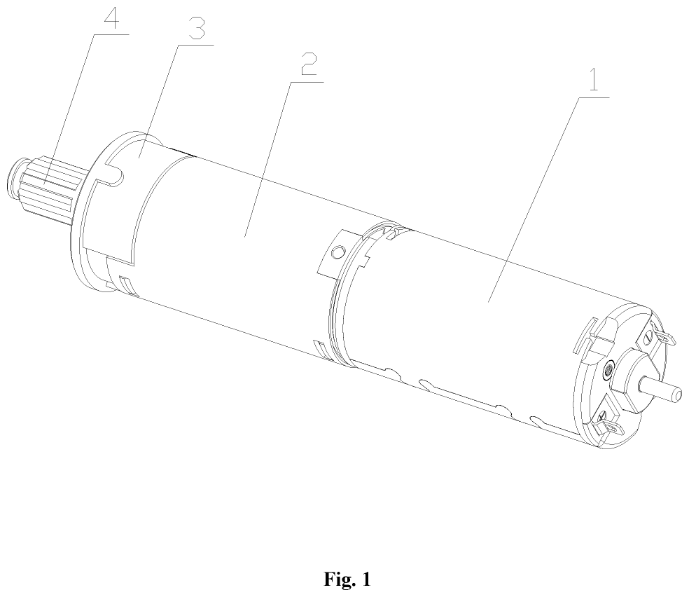

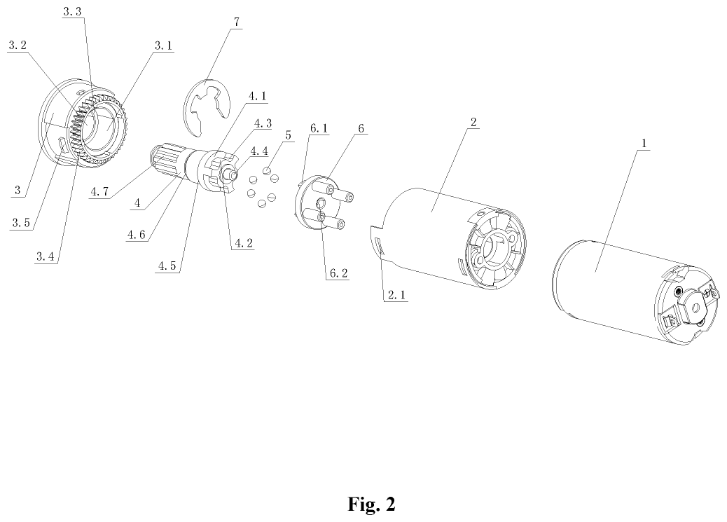

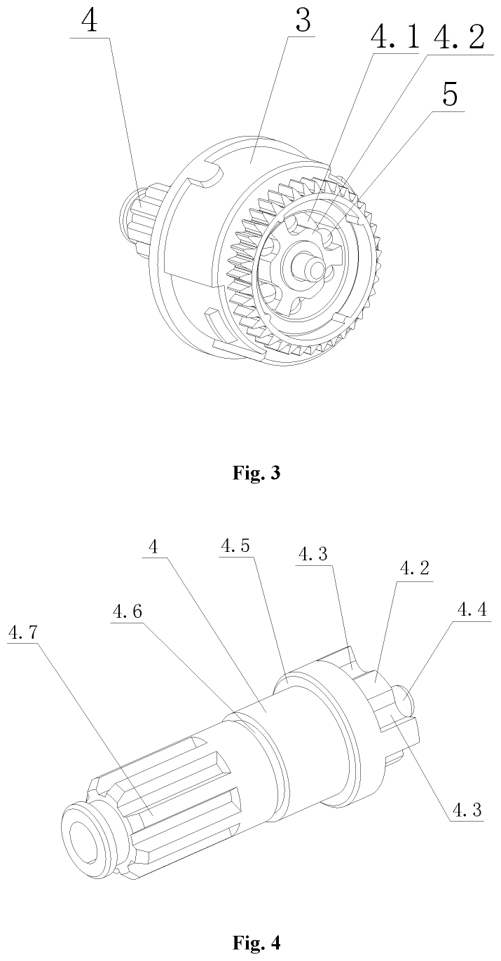

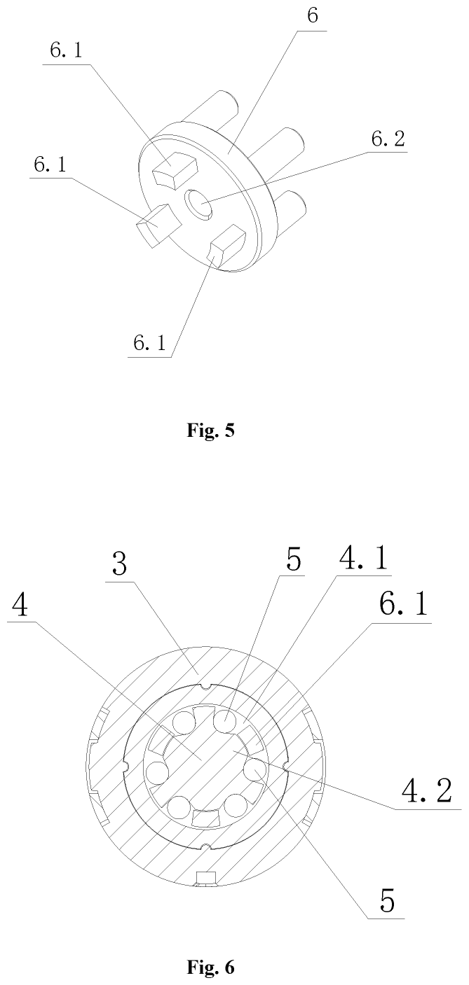

As shown in FIGS. 1-6, a non-return mechanism for a motor of an electric curtain comprises a motor 1 and a gearbox 2 that are successively connected. The output end of the gearbox 2 is connected with a non-return component. The non-return component comprises a flange 3, an output shaft 4 and non-return blocks 5. The flange 3 is internally provided with an accommodating cavity 3.1. The output end of the gearbox 2 is provided with an output bracket 6. The output bracket 6 is in unidirectional drive fit with one end of the output shaft 4 toward the gearbox 2 and they fit within the accommodating cavity 3.1. The non-return blocks 5 are arranged at the joint of the output bracket 6 and the output shaft 4. The flange 3 is connected with the gearbox 2. The end portion of one end of the output shaft 4 toward the gearbox 2 is provided with at least one arc-shaped groove 4.1 that is concave along the radial direction. The non-return block 5 is accommodated within the arc-shaped groove 4.1. A poke rod 6.1 for poking the non-return block 5 extends from the output bracket 6 and fits within the arc-shaped groove 4.1. A brake block 4.2 is bulged from the bottom of the arc-shaped groove 4.1 and divides the arc-shaped groove 4.1 into two symmetrical cavities 4.3 that are intercommunicated to each other. The non-return blocks 5 are symmetrically accommodated within the two cavities 4.3. The poke rod 6.1 extends into the arc-shaped groove 4.1 and between two non-return blocks 5. The non-return blocks 5 are in clearance fit with both the inner walls of the cavities 4.3 and the inner wall of accommodating cavity 3.1, that is to say, the movable space enclosed by the inner wall of the accommodating cavity 3.1 and the inner walls of the cavities 4.3 is greater than the size of the non-return block 5, and the clearance ranges from 0.1 mm to 2 mm One end of the output shaft 4 away from the gearbox 2, serves as a driving head 4.7, for linkage with an external portion. The driving head 4.7 directly drives a curtain to open or close by connecting with an external rotary joint.

The distance from the bulged surface of the brake block 4.2 to the inner wall of the accommodating cavity 3.1 is greater than the thickness of the poke rod 6.1 but less than the width of the non-return block 5. That is to say, the poke rod 6.1 may rotate in the arc-shaped groove 4.1 in forward or reverse direction. The poke rod 6.1 moves within the left and right two cavities 4.3 over the brake block 4.2 so as to poke the non-return blocks 5 to push against the inner wall of the arc-shaped groove 4.1 and drive the output shaft 4 to rotate synchronously. However, the non-return blocks 5 merely move in respective cavities 4.3 due to the arranged brake blocks 4.2 in the center and are incapable of going over the brake blocks 4.2. Moreover, the closer the non-return block 5 approaches the brake block 4.2, the smaller the movable clearance between the non-return block 5, and the inner wall of the accommodating cavity 3.1 and the bulged surface of the brake block 4.2 becomes, and finally the non-return block 5 is clamped between the inner wall of the accommodating cavity 3.1 and the bulged surface of the brake block 4.2, thereby limiting reverse driving of the output shaft 4, thus an external force or own gravity of the curtain is prevented from being applied to the output bracket 6, the gearbox 2 and the motor 1 are protected and their service lives are prolonged.

Preferably, three arc-shaped grooves 4.1 are available and disposed along the circumferential direction of the end portion of one end of the output shaft 4 toward the gearbox 2 equidistantly. Six non-return blocks 5 are provided. The quantity and positions of the poke rod 6.1 correspond to those of the arc-shaped groove 4.1. The above is a preferred embodiment in which whether driving of the output bracket 6 or non-return operation of the non-return blocks 5 is uniform in force bearing, therefore, deviation is avoided, wear is uniform, service life is substantially same.

The center of the end portion of one end of the output shaft 4 toward the gearbox 2 is provided with a locating shaft 4.4 in a protruded manner. A shaft hole 6.2 matched with the locating shaft 4.4 is formed on the output bracket 6. Match of the locating shaft 4.4 and the shaft hole 6.2 renders coaxial rotation of the output bracket 6 and the output shaft 4, avoiding deviation in the rotation process, reducing wear and lowering noise.

One end of the flange 3 away from the gearbox 2 is provided with a through hole 3.2. The through hole 3.2 is communicated with the accommodating cavity 3.1. There forms a step surface 3.3 on the joint of the through hole 3.2 and the accommodating cavity 3.1. A locating step 4.5 matched with the step surface 3.3 is formed on the output shaft 4. One end of the output shaft 4 away from the gearbox 2 penetrates through the through hole 3.2 and is exposed outside the flange 3. An annular slot 4.6 is formed on the portion of the output shaft 4 exposed outside the flange 3. A circlip 7 is clamped on the annular slot 4.6. The circlip 7 clings to the end surface of one end of the flange 3 away from the gearbox 2. Through match of the step surface 3.3 and the locating step 4.5, and match of the circlip 7 with the annular slot 4.6 and the end surface of the flange 3, the output shaft 4 is limited from axial movement, such that match of the poke rod 6.1 with the non-return block 5, the arc-shaped groove 4.1 and the brake block 4.2 is prevented from being influenced by axial movement of the output shaft 4.

The non-return blocks 5 are spheres. Preferably, the non-return blocks are steel balls. When the non-return mechanism of the present invention operates, friction of the steel balls with the inner wall of the accommodating cavity 3.1, the inner wall of the arc-shaped groove 4.1 and the bulged surface of the brake block 4.2 belong to rolling friction, featuring less friction resistance and wear, longer service life, and convenience in replacement and maintenance.

One end of the flange 3 toward the gearbox 2 is provided with a circle of outer gear ring 3.4. The outer gear ring 3.4 is matched with an inner gear ring of the gearbox 2 so as to improve the close-fit performance of the flange 3 and the gearbox 2. In addition, at least two fasteners 3.5 are equidistantly arranged on the peripheral wall of the flange 3. Clamping grooves 2.1 matched with the fasteners 3.5 are accordingly formed on the gearbox 2. The fasteners 3.5 are matched with the clamping grooves 2.1 so as to fixedly connect the flange 3 on the gearbox 2.

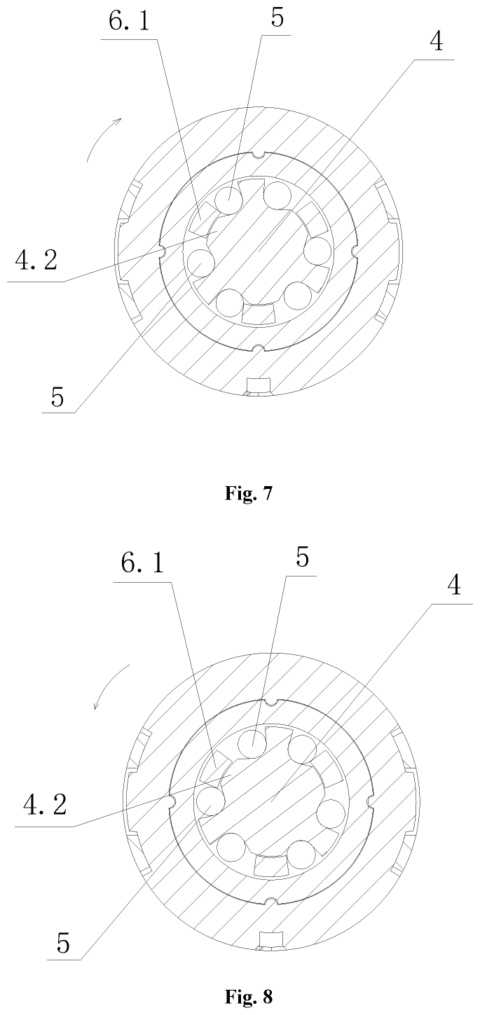

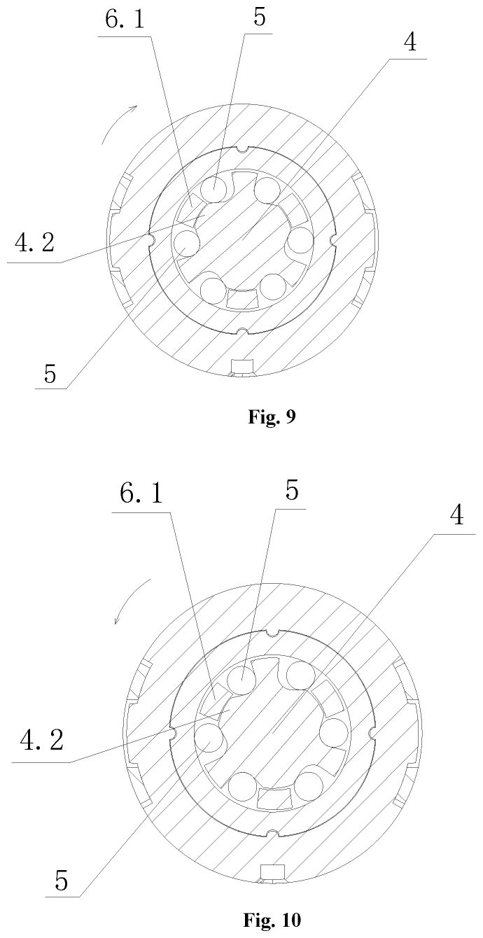

The non-return mechanism for a motor of an electric curtain provided by the present invention works as the following principle: when the motor 1 operates (i.e., the motor rotates in forward or reverse direction), it drives the gearbox 2 to propel the output bracket 6 to rotate; the poke rod 6.1 on the output bracket 6 rotates within the arc-shaped groove 4.1; the poke rod 6.1 penetrates through the clearance between the brake block 4.2 and the inner wall of the accommodating cavity 3.1 to move between two cavities 4.3 to and fro; the poke rod 6.1 rotationally pokes the steel balls in the arc-shaped groove 4.1; FIG. 7 shows that the poke rod 6.1 only pokes the steel balls at the right side of the brake block 4.2 when in forward rotation, while FIG. 8 shows that the poke rod 6.1 only pokes the steel balls at the left side of the brake block 4.2 when in reverse rotation, therefore, the poke rod 6.1 merely pokes the steel balls at one side in forward or reverse rotation; the poked steel balls are not clamped in the clearance between the inner wall of the accommodating cavity 3.1 and the bulged surface of the brake block 4.2 as being pushed by the poke rod 6.1, while the steel balls that are not poked by the poke rod 6.1 are in the cavities 4.3 and thus are not clamped; the poked steel balls push against the inner wall of the arc-shaped groove 4.1 so as to drive the output shaft 4 to rotate, and directly drives a curtain to open or close by connecting with an external rotary joint via the driving head 4.7. When the motor 1 ceases, the output bracket 6 stops rotation, the curtain, under the effect of an external force (blowing by wind or pulling by hands) or own gravity of the curtain drives the output shaft 4, once the output shaft 4 begins to rotate in forward direction (see FIG. 9), the brake block 4.2 in the arc-shaped groove 4.1 pushes the steel balls at the right side, and then the steel balls are clamped between the bulged surface of the brake block 4.2 and the inner wall of the accommodating cavity 3.1 for the distance from the bulged surface of the brake block 4.2 to the inner wall of the accommodating cavity 3.1 is less than the width of the steel balls. Similarly, if the output shaft 4 rotates in revere direction (see FIG. 10), the steel balls at the left side are clamped between the bulged surface of the brake block 4.2 and the inner wall of the accommodating cavity 3.1 so as to prevent the output shaft 4 from reversely driving the output bracket 6. Whether in forward or reverse rotation, the output shaft 4 is locked, therefore, the external force or own gravity of the curtain cannot be applied to the output bracket 6 so as to achieve a non-return effect. Hence, the curtain stops at the position as soon as the motor 1 ceases, free of any position deviation caused by the external force or own gravity of the curtain. At the same time, the motor 1 and the gearbox 2 are well protected.

The flange 3, the output shaft 4 and the steel balls jointly cooperate with the output bracket 6 of the gearbox 2 so as to achieve unidirectional drive fit. The output bracket 6 drives the output shaft 4 to rotate, but the output shaft 4 cannot drive the output bracket 6 to reversely drive. The non-return component effectively provides a non-return force which not only steadily maintains the curtain at the required position when the motor 1 stops, but also prevents the gearbox 2 and motor 1 from being damaged. Besides, the non-return component directly drives the output bracket 6 at the output end of the gearbox 2, structure is simple, and requirements on design are greatly lowered, therefore, cost is low. By adoption of small cogging torque, rotation speed of the motor 1 is improved, and energy consumption of the motor of the curtain is cut down.

It should be noted that, the above embodiments are merely illustrative, rather than restrictive, to the technical solutions of the present invention. Although the present invention has been explained in detail with reference to the above embodiments, it should be understood by those skilled in the art that, modifications to the technical solutions of the embodiments or even equivalent substitutions for partial technical features therein are allowed. However, these modifications or substitutions shall not make the essence of the technical solutions depart from the spirit and scope defined by the technical solutions of the present invention.

We claim:

1. A non-return mechanism for a motor of an electric curtain, comprising a motor (1) and a gearbox (2) that are successively connected, wherein the output end of the gearbox (2) is connected with a non-return component; the non-return component comprises a flange (3), an output shaft (4) and a non-return block (5); the flange (3) is internally provided with an accommodating cavity (3.1); the output end of the gearbox (2) is provided with an output bracket (6); the output bracket (6) is in unidirectional drive fit with one end of the output shaft (4) toward the gearbox (2) and they fit within the accommodating cavity (3.1); the non-return block (5) is arranged at the joint of the output bracket (6) and the output shaft (4); the flange (3) is connected with the gearbox (2).

2. The non-return mechanism for a motor of an electric curtain of claim 1, wherein the end portion of one end of the output shaft (4) toward the gearbox (2) is provided with at least one arc-shaped groove (4.1) that is concave along the radial direction; the non-return blocks is accommodated within the arc-shaped groove (4.1); a poke rod (6.1) for poking the non-return block (5) extends from the output bracket (6) and fits within the arc-shaped groove (4.1).

3. The non-return mechanism for a motor of an electric curtain of claim 2, wherein a brake block (4.2) is bulged from the bottom of the arc-shaped groove (4.1) and divides the arc-shaped groove (4.1) into two symmetrical cavities (4.3) that are intercommunicated to each other; the non-return blocks (5) are symmetrically accommodated within the two cavities (4.3); the poke rod (6.1) extends into the arc-shaped groove (4.1) and locates between two non-return blocks (5).

4. The non-return mechanism for a motor of an electric curtain of claim 3, wherein the distance from the bulged surface of the brake block (4.2) to the inner wall of the accommodating cavity (4.3) is greater than the thickness of the poke rod (6.1) but less than the width of the non-return block (5).

5. The non-return mechanism for a motor of an electric curtain of claim 3, wherein the non-return blocks (5) are in clearance fit with both the inner walls of the cavities (4.3) and the inner wall of the accommodating cavity (3.1).

6. The non-return mechanism for a motor of an electric curtain of claim 3, wherein the quantity of arc-shaped grooves (4.1) is three and the arc-shaped grooves (4.1) are arranged along the circumferential direction of the end portion of one end of the output shaft (4) toward the gearbox (2) equidistantly; six non-return blocks are provided, and the quantity and positions of the poke rod (6.1) correspond to those of the arc-shaped groove (4.1).

7. The non-return mechanism for a motor of an electric curtain of claim 2, wherein the center of the end portion of one end of the output shaft (4) toward the gearbox (2) is provided with a locating shaft (4.4) in a protruded manner; a shaft hole (6.2) matched with the locating shaft (4.4) is formed on the output bracket (6).

8. The non-return mechanism for a motor of an electric curtain of claim 1, wherein one end of the flange (3) away from the gearbox (2) is provided with a through hole (3.2); the through hole (3.2) is communicated with the accommodating cavity (3.1); a step surface (3.3) is formed on the joint of the through hole (3.2) and the accommodating cavity (3.1); a locating step (4.5) matched with the step surface (3.3) is formed on the output shaft (4); one end of the output shaft (4) away from the gearbox (2) penetrates through the through hole (3.2) and is exposed outside the flange (3); an annular slot (4.6) is formed on the portion of the output shaft (4) exposed outside the flange (3); a circlip (7) is clamped on the annular slot (4.6); the circlip (7) clings to the end surface of one end of the flange (3) away from the gearbox (2).

9. The non-return mechanism for a motor of an electric curtain of claim 1, wherein the non-return blocks (5) are spheres.

10. The non-return mechanism for a motor of an electric curtain of claim 1, wherein one end of the output shaft (4) away from the gearbox (2), is used as a driving head (4.7) for linkage with an external portion.
